(19) United States
(12) Patent Application Publication
(10) Pub. No.: US 2007/0094500 A1
(43) Pub. Date: Apr. 26, 2007

(54) System and Method for Investigating Phishing Web Sites

(75) Inventors: Marvin Shannon, Pasadena, CA (US); Wesley Boudville, Perth (AU)

Correspondence Address: MARVIN SHANNON, 3579 EAST FOOTHILL BLVD, #328, PASADENA, CA, 91107, US

(73) Assignees: Marvin Shannon, Pasadena, CA (US); Wesley Boudville, Perth (AU)

(21) Appl. No.: 11/163,463

(22) Filed: Oct. 20, 2005

(51) Int. Cl. H04L 9/00

(52) U.S. Cl. 713/170

(57) ABSTRACT

We investigate phishing web sites, by finding domain clusters using our antispam methods, from both phishing and non-phishing messages. We can find related web sites and analyze these for possible phishing. This can be done at an ISP, or by an analysis company, or in an appliance. We extend our anti-phishing tag, to let senders send personalized messages to a few recipients, where the messages have links or text to be validated in a lightweight fashion. The functionality of plug-ins is extended to let the user indicate that a web page or message is fraudulent, and to upload this to an Aggregator. An Aggregator can have a hierarchy of subAggregators, that validate companies, and act to distribute the workload from plug-ins. Messages and web pages without our tag can be classified. A company publishes a Restricted List of its pages containing sensitive operations, like user login. This information can be used by an ISP or plug-in against links or text in a message or web page. The list can be used as a negative template. So that on another website, if pages are found similar to those on the list, it would be a strong indication of phishing. A phishing message that just points to a phisher's website might be detected, by spidering the website and searching for the names of various banks. If a name is found, then a comparison can be done with the bank's website. The bank's pages are used as a positive template, to search for a phisher mimicking them. We also search for labels of user input widgets, and compare these to a table of key words for sensitive personal data.

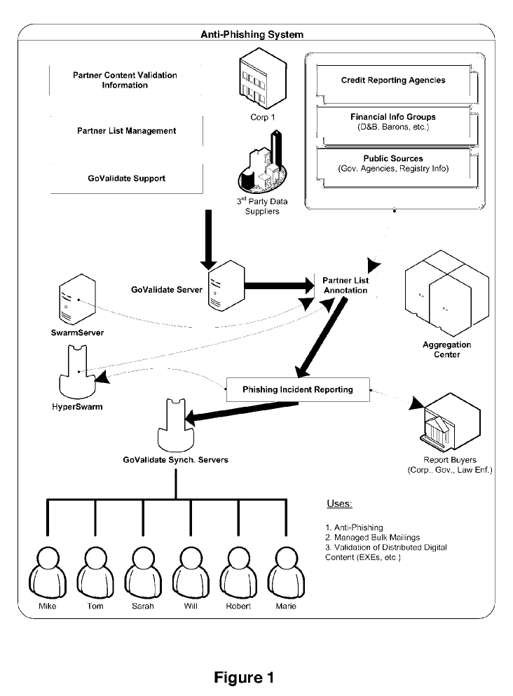

### CROSS-REFERENCES TO RELATED APPLICATIONS

This application claims the benefit of the filing date of U.S. Provisional Application, No. 60/552640, “System and Method for Investigating Phishing Web Sites”, filed Oct. 22, 2004, which is incorporated by reference in its entirety. It also incorporates by reference in its entirety the U.S. Provisional Application, No. 60/522644, “System and Method for Detecting Phishing Messages In Sparse Data Communications”, filed Oct. 24, 2004.

### REFERENCES CITED

Antiphishing Working Group, antiphishing.org.

“Worldwide phishing attacks originate from less than five zombie network operators”, securitypark.co.uk, 19 Oct. 2004.

### TECHNICAL FIELD

This invention relates generally to information delivery and management in a computer network. More particularly, the invention relates to techniques for automatically classifying electronic communications and web pages as phishing or non-phishing.

### BACKGROUND OF THE INVENTION

Phishing often involves an unwary user being redirected, via links in an electronic message, to a web site (“pharm”) run by the phisher. The phishing message often pretends to be from a bank. Since with email, forging the sender line is trivial. Plus, the text of the message reinforces this false impression; typically suggesting or even requiring that the user click on a link that goes to the bank, and then to login to her account. The visible text of the link pretends to be the bank. But in practice, the link really goes to the pharm, where the phisher has made up dummy web pages that look like the bank's pages.

The Antiphishing Working Group (antiphishing.org) has documented a heavy rise in phishing globally, up to September 2004. Its website also furnishes examples of phishing messages and describes, or links to descriptions, of existing antiphishing methods.

### SUMMARY OF THE INVENTION

The foregoing has outlined some of the more pertinent objects and features of the present invention. These objects and features should be construed to be merely illustrative of some of the more prominent features and applications of the invention. Other beneficial results can be achieved by using the disclosed invention in a different manner or changing the invention as will be described. Thus, other objects and a fuller understanding of the invention may be had by referring to the following detailed description of the Preferred Embodiment.

We investigate phishing web sites, by finding domain clusters using our antispam methods, from both phishing and non-phishing messages. We can find related web sites and analyze these for possible phishing. This can be done at an ISP, or by an analysis company, or in an appliance.

We extend our anti-phishing tag, to let senders send personalized messages to a few recipients, where the messages have links or text to be validated in a lightweight fashion.

The functionality of plug-ins is extended to let the user indicate that a web page or message is fraudulent, and to upload this to an Aggregator. An Aggregator can have a hierarchy of subAggregators, that validate companies, and act to distribute the workload from plug-ins.

Messages and web pages without our tag can be classified. A company publishes a Restricted List of its pages containing sensitive operations, like user login. This information can be used by an ISP or plug-in against links or text in a message or web page. The list can be used as a negative template. So that on another website, if pages are found similar to those on the list, it would be a strong indication of phishing.

A phishing message that just points to a phisher's website might be detected, by spidering the website and searching for the names of various banks. If a name is found, then a comparison can be done with the bank's website. The bank's pages are used as a positive template, to search for a phisher mimicking them. We also search for labels of user input widgets, and compare these to a table of key words for sensitive personal data.

### BRIEF DESCRIPTION OF THE DRAWINGS

There is one drawing. It shows the general configuration on a computer network of various elements in our Invention.

### DETAILED DESCRIPTION OF THE PREFERRED EMBODIMENT

What we claim as new and desire to secure by letters patent is set forth in the following claims.

We described a lightweight means of detecting phishing in electronic messages, or detecting fraudulent web sites in these earlier U.S. Provisionals: No. 60/522,245 (“2245”), “System and Method to Detect Phishing and Verify Electronic Advertising”, filed Sep. 7, 2004; No. 60/522,458 (“2458”), “System and Method for Enhanced Detection of Phishing”, filed Oct. 4, 2004; No. 60/552,528 (“2528”), “System and Method for Finding Message Bodies in Web-Displayed Messaging”, filed Oct. 11, 2004.

We will refer to these collectively as the “Antiphishing Provisionals”.

Below, we will also refer to the following U.S. Provisionals submitted by us, where these concern primarily antispam methods: No. 60/320,046 (“0046”), “System and Method for the Classification of Electronic Communications”, filed Mar. 24, 2003; No. 60/481,745 (“1745”), “System and Method for the Algorithmic Categorization and Grouping of Electronic Communications, filed Dec. 5, 2003; No. 60/481,789, “System and Method for the Algorithmic Disposition of Electronic Communications”, filed Dec. 14, 2003; No. 60/481,899, “Systems and Method for Advanced Statistical Categorization of Electronic Communications”, filed Jan. 15, 2004; No. 60/521,014 (“1014”), “Systems and Method for the Correlations of Electronic Communications”, filed Feb. 5, 2004; No. 60/521,174 (“1174”), “System and Method for Finding and Using Styles in Electronic Communications”, filed Mar. 3, 2004; No. 60/521,622, “System and Method for Using a Domain Cloaking to Correlate the Various Domains Related to Electronic Messages”, filed Jun. 7, 2004; No. 60/521,698, “System and Method Relating to Dynamically Constructed Addresses in Electronic Messages”, filed Jun. 20, 2004; No. 60/521,942 (“1942”), “System and Method to Categorize Electronic Messages by Graphical Analysis”, filed Jul. 23, 2004; No. 60/522,113, “System and Method to Detect Spammer Probe Accounts”, filed Aug. 17, 2004; No. 60/522,244, “System and Method to Rank Electronic Messages”, filed Sep. 7, 2004.

We will refer to these collectively as the “Antispam Provisionals”.

Here, we extend the analysis of the Antiphishing Provisionals to other methods that can be done at the enterprise level. Consider an ISP using our earlier methods to detect phishing. When the ISP found a phishing message by these methods, we suggested that it could manually or algorithmically subject the message to more tests. We now elaborate on this.

Suppose we are that ISP. Assume that the message purports to be from sender@bank0.com. The links that are in the message, and which have base domains not in the Partner Lists of Bank0, cause us to mark the message as phishing. This can be done for each message considered in isolation from other messages. (It is assumed that we have access to these Partner Lists, possibly from an Aggregator.)

Powerful new avenues emerge if we apply our analysis from the Antispam Provisionals. By constructing the Bulk Message Envelopes [BMEs] (“0046”), we can take a broader view of the extent of a given phishing attack. The alternative method, of simply counting up the number of exact copies of a given message, is too vulnerable to the phisher introducing spurious unique variability into each copy of her message. Our BMEs are robust against much such variability, if that variability is invisible to the recipient. For variability which is visible, like visible random text, it degrades the message. Unlike the case of non-phishing spam, phishing messages are under a tight constraint to look as reputable as possible. Thus the phisher has to avoid visible random text, or any other visible randomness. In this respect, the use of BMEs against phishing may have higher efficacy than against general non-phishing spam.

By our methods of the Antiphishing Provisionals, we can obtain a corpus of suspected phishing messages. This corpus can be input into our analysis methods of the Antispam Provisionals. We can find clusters of domains, for example (“1745”). In the general case of non-phishing spam, a domain cluster can be used to classify or categorize those domains. But the goods or services that those domains sell might be legal, like playing cards or laser printer cartridges. However, if we start from a corpus of phishing, then we can make far stronger statements. Any domains found in the messages, and which are not in the appropriate Partner List, may be assumed to be for an illegal intent. Plus, any cluster containing such domains strongly suggests a nefarious grouping.

Of course, it can be expected that phishers may react to this by inserting links to innocuous third parties. To combat this, we can make exclude lists, or white lists, of domains (“0046”). These might include entire ranges of domains, like .mil or .gov or .gov.au, for example, that we consider highly unlikely to be involved in phishing.

Let Amy be a phisher. Unlike writing regular non-phishing spam, Amy cannot easily insert a link to an innocent site. Firstly, this link must be valid, and not within a comment. Secondly, a phishing message tries as much as possible to be about a target, like a bank. Hence it often has several links to the bank's actual website. With often only one crucial link to Amy's website or network address. Any link to a third party increases the risk that the reader will see her message as fake.

So in what follows, we assume that we have applied any exclude or white lists to the lists of domains or network addresses that we found from the phishing messages, and which were not in the Partner Lists for those presumed senders.

One Phishing Cluster

Consider a cluster of phishing domains. Why does it exist? One way that it might arise is if Amy takes over several computers (perhaps via viruses) and uses these as destinations for the phishing links in messages. Or Amy purchases several domain names, installs these at actual network addresses and then has servers running at the domains, to accept input from unsuspecting users. Another possibility is that a skilled person might craft a phishing message, and then sell this as a template (“0046”) to others, each of whom might insert her own address into the phishing link, and then send out these messages. Notice that these phishers who actually send the messages need not actually know each other. Their only connection is via the person they bought the original message from. Our clustering method can find these groups.

A cluster can arise out of one or more of the above reasons, and possibly other reasons. Further analysis can be done. We can search the DNS name registries for the owners of record of the domains. and other related data held by the registries. Clearly, if several domains are owned by the same person, then we have corroborative evidence linking those domains, separate from and independent of our clustering methods. But suppose we have different owners. Note that owner data in a name registry is not absolutely definitive. Different name registries can have different policies as to how they authenticate the name of someone who wants to buy a domain name. In fact, some name registries may have no such policy, or only a most minimal one. For example, if you pay for a domain name with a credit card, the registry might use the existence of a valid credit card as the authenticator for the name on the card. But if you pay with a postal money order, a registry might just accept that and accept whatever name and address you give to them. Keep in mind that the registries compete with each other, and with a registration fee around $US10-20, no registry can afford to spend much effort authenticating its customers.

Plus, instead of Amy submitting false owner data to a registry, she can pay others to submit real data about themselves, and have these people be the owners of record of her domains.

Looking at the registry data for the phishing domains, we can see if any were registered close to each other in time. If two domains were registered on the same day, say, but to different owners, then this could be a heuristic flag, or style, as we term it (“1174”), suggesting a possible correlation. While owner data in a registry might be false, the registration dates are written by the registry itself, and can be regarded as reliable. (Assuming that the registry itself has not been subverted.) We can use this style to possibly detect if Amy has been behind the registration of those domains, even if she gave false data.

Another method is to see if any of the cluster domains are close to each other spatially. There is software that can map from most Internet Protocol [IP] addresses to geographic locations. Of course, what spatially “close” means might have to be empirically determined or adjusted by us, based on our experience or other logic. But if some domains are found to be close in this fashion, we can group them for further investigation, and also set another style.

Another method is to see if any of the domain owners are close to each other spatially, based on the owners' data at the registries. Some of this data might be false. But even if an owner address is false, it might give some rough geographic indication of the real owner. A style can be used here.

It is straightforward to also see if any domain names in the cluster map to the same IP address. This can be extended to see if IP addresses that correspond to the domains are close to each other, in the IP address space. A related idea is to group the domains by the ISPs that host them. For example, suppose Amy buys two domains, giving false owner data. She still needs to find ISPs that can host them. Sometimes, there may only be one or two ISPs in her vicinity to choose from. Styles can be defined here.

Several Phishing Clusters

Now consider what happens if we have a set of phishing clusters, where each cluster is disjoint from other clusters, (“1745”) by explicit construction. Different clusters may be construed as belonging to different phishers. The number of original messages or recipients in each cluster may be used to rank the clusters. So that, for example, clusters with the most messages or number of recipients are investigated first, because these may cause the most damage.

We can also search for any associations between clusters. For example, “1942” lets us look for phishers that might be using common mailing lists.

Another idea is to search different data for information that might link phishing clusters. This is the basic method in “1014”.

One method is to look at the non-phishing messages using the Antispam Provisionals, and form domain clusters. If a non-phishing cluster has two domains that are in two different phishing clusters, then we can associate the phishing clusters with each other. As a higher level of structure. This can be depicted as a graph, with each phishing cluster being a node, and a vertex connects two nodes if found from the non-phishing data. Plus, the weight on the vertex can be some measure of the “strength” of this association. For example, it might be derived from the number of domains in one or both of the phishing clusters that are in one or more common non-phishing clusters. Or it might be derived from the number of messages received by those domains. Or from the number of users (recipients) associated with those domains.

It is useful to consider why there might be such linkages between 2 phishing clusters in the first place. (This is similar to our discussion of the overlapping business models of spammers and link farms in “1014”.) If Amy sets up her phisher domain at an IP address and has a web server running, there is a cost associated with it. She might want to defray that cost by earning extra income from spam, prior to sending out phishing messages pointing to it. We say prior, because Amy has to expect that the phishing will lead to her web site being shut down within a few days. We have observed that many spammers can be detected in domain clusters of spam. Possibly in part because they share mailing lists and templates of messages. So if Amy decides to spam, chances are that she may join some informal network of spammers, where this network might show itself as a domain cluster. This spammer network may well have other phishers doing likewise. Hence, we can associate different phisher clusters.

Of course, if Amy decides not to do this, then she will not cause her phishing cluster to be linked to another phishing cluster. But for her phishing cluster not to be actually linked, all the other true owners of domains in the cluster must also refrain from spamming. If they do that, perhaps in reaction to our method, then it reduces an income source, and hence it increases the pressure on them.

But quite aside from looking for associations between 2 phisher domains, it is also worth doing the following. For each phishing domain, see if it is in a cluster arising from non-phishing messages. If so, then that cluster, or maybe just domains in it that are within a few hops in the cluster from the phishing domain, might be subject to extra scrutiny. Because there could be other reasons why Amy might want to send spam pointing to her domain. She might be harvesting names and credit card numbers, or other personal information, just as she does with her phishing. Plus, this non-phishing cluster or the domains in it close to her domain, might actually be controlled by her.

We can use the existence of one or more phishing domains in a cluster found from non-phishing messages to classify that cluster as suspect. With the cluster, we could associate the number of such phishing domains in it. Hence the greater the number, the more suspect the cluster. We can consider this as a style of the cluster.

Optionally, domains in this cluster might be put into some special list, that suggests possible phisher affiliation. Future messages received, that link to those domains, or purport to be from them, might be subject to other antiphishing analysis.

Another reason for looking at the other domains in this non-phishing cluster is to find if they are being used to exploit identity information. Consider what happens if Amy manages to find a host of personal information by phishing. If it is credit card information, she can try to purchase goods and services, by pretending to be the credit card holders. The problem is that this is small scale. Instead, for greater renumeration, she needs some means of charging these credit cards, and as many of these as possible, usually by acting as a merchant. But in this case, the credit card organizations need to validate that she is a merchant. One of the ways that she can establish this is to pretend to be a merchant who sells on the Internet. Hence, she might set up a domain, different from where she will point her phishing. This merchant domain will have a web site. Plus, she might send spam pointing to it, so that she can bill for actual sales and establish a track record, before phishing.

The merchant domain might be in the cluster with her phishing domain. Or, given a phishing domain, we can take its IP address and then find any non-phishing clusters with members close to it, in IP space.

In October 2004, CipherTrust released an analysis of phishing, from mail messages from many countries, in the first two weeks of that month. (“Worldwide phishing attacks originate from less than five zombie network operators”, SecurityPark.co.uk, 19 Oct. 2004.) They found that most of the phishing came from different sets of 1000 zombies—which are computers taken over by viruses, and then used to send or receive messages across the Internet. More to the point, 70% of the zombies were also issuing spam. So empirically, there is indeed a correlation between phishing and non-phishing spam. This may be for the reasons we have suggested above, and possibly for other reasons. In either case, our above methods should have merit in finding any correlations.

Another method is to use results from antivirus efforts. For example, if some viruses were found to be able to send data to other network addresses, then it might be useful to search for any correlations between those addresses and those of the phishers.

It is also possible to use the phishers' domains (and corresponding IP addresses) in antivirus efforts. For example, one of these efforts might including scanning a message or found virus, looking for the presence of the phishers' domains or (more likely) addresses.

Note also that our methods of detecting phishing can do so very quickly. From that early detection of phishing domains, we can do the above analysis and look for possible merchant domains, before Amy can use them, or before she can use them with much data.

Related to this, we can send spiders to crawl each domain in the cluster that has a phishing domain, or is near a phishing domain. They could return entire web pages, and follow links, up to some limit of hops. (An n-ball in web space.) With this cross-Electronic Communication Modality approach, we could apply our canonical steps in “0046”, to find any similarities between the pages. Which would suggest a common author. We could also apply methods like Bayesians, neural networks, expert systems or artificial intelligence, on the pages, to try and discern what the meanings of the web sites are.

There is also another usage of domain clusters from non-phishing messages. Suppose that from some phishing messages, the recipients get fooled and give their personal data to Amy. Suppose these involve credit cards, and Amy has a merchant domain that falsely bills the credit cards. When the credit card organization determines that these are fake, it can tell us what domain was involved. Then we can search our domain clusters and find the cluster that the merchant domain is in. The other domains in the cluster can be subject to extra scrutiny by the credit card organization, and possibly other financial or governmental organizations. (It can be seen that this is not necessarily restricted to domains involved in phishing.) This is after the fact of the initial false billing. But it does allow for pre-emptive methods against related cluster domains, that may not have yet been “activated” by her in actual fraudulent billing.

Most of the above involved just one metadata space, domains. We can also use the other metadata spaces in “0046”, to further associate a phishing domain with other domains. Essentially, by searching in those spaces for any correlations between the phishing domain and another domain. For example, suppose the phishing messages have relay paths that are partially faked by Amy. Even the faked domains can be used. We could look for non-phishing messages with similar or identical paths, and see which domains these messages point to (if any).

Aggregator or Appliance

In the above, we assumed that we were an ISP receiving electronic messages. But it is also possible that we might be some other organization that performs this analysis, like the Aggregator in “2458”. From the specialized nature of some of the above methods, an ISP might prefer that another organization do this. From that ISP, the organization could get BMEs made from the ISP's messages, using the steps in “0046”. This would preserve the ISP's members' privacy since we do not need to see the original messages. We would also need phishing information generated from any of our methods in the Antiphishing Provisionals and in this Invention, that were being performed at the ISP.

Our organization might act in the fashion of this Invention, and as an intermediary between the ISPs and financial companies and any other companies targeted by phishers.

A related approach is for the algorithmic methods in this Invention and earlier Provisionals to be encoded in an enterprise level software package. This might be run by an ISP. Or the package might be instantiated within a computer, as an appliance that could be installed at an ISP. Or, indeed, at any organization that receives electronic messages. If such appliances were to be deployed, they would send results to their host companies, and also to our central analysis organization, if it existed.

Personalized Validated Messages

We extend the discussion in “2458” of using tags in electronic messages or web pages, to validate the links in these. There, we defined a tag with several optional attributes. Those attributes had the property that they enabled the validation of mass mailings sent out by the bank. But suppose someone at the bank wanted to send out a message to one person, or perhaps just a few persons. A simple extension of “2458” lets us do this, with the validation of any links in it. In the tag, add a variable, called “few”, say, as follows:
<notphish a=“bank0.com” few=“abcdefgh0123”/>

Its value is an id that is used by the bank. Consider this process. A person at the bank, Costas@bank0.com, writes to Lucy@somewhere.com. For example, Costas may be a security officer advising Lucy about her account. He puts links to third party sites that he thinks might be informative to her. In general, these sites are not on Bank0's Partner Lists, which might be mostly used for advertising. Costas writes his message in a special message writing program, Kappa. When he is finished writing, and presses “send”, Kappa extracts the links he wrote, and reduces these to base domains. It also writes the above tag into the message. Where it generates or obtains a value for “few” that has not been used before by the bank, or at least recently, for this particular choice of sender address and set of base domains. The obtaining of the value might be from some other program. Kappa might also find a hash of the text.

Kappa gathers this data—(sender address,base domains, “few” value, hash), and stores it in a database or sends it to some other program, Gamma, which is associated with the bank's implementation of the methods in “2458”. Kappa also sends Costas' message, with its addition of the tag, to the mailer program that handles outgoing mail.

Note that the value of “few” is not necessarily a unique identifier of the message. It could be unique for a given combination of sender address and set of base domains. So if Costas were to send a different message, that had the same base domains, then the previous value of “few” could be reused here. This is in contrast to any method that makes an id using a message body as part or all of the input.

Then suppose Lucy gets this message and reads it in her browser, which is running the plug-in. It takes the above tag and sends it to Bank0.com. It could also send the base domains found from the message. At Bank0, the listening service gets the tag, finds the “few” variable and hence sends the tag, plus any associated information from Lucy, like the domains, to a process or program, that might be called Gamma. That program then compares any uploaded domains to the above approved list that Costas made. If there are any not on the list, then it returns “no” to Lucy's plug-in, which will not validate the message. If the plug-in did not upload any domains, then Costas' list is downloaded to the plug-in, which then makes the comparison. If a hash identifies the message, then this might be sent to the plug-in for comparison with the hash found by the plug-in from the received message.

Of course, Gamma need not be distinct from the listening service. Such implementation details are irrelevant to the gist of this method.

Optionally, the plug-in could send this query to an Aggregator. But preferably, the plug-in should communicate directly with the bank. It reduces the amount of information that an Aggregator needs to handle. Plus, given the possibly sensitive nature of the original message (as opposed to a mass mailing), it is safer that only two parties be involved in this conversation. Less chance for a phisher or other hostile entity to intervene.

Note that as in “2458”, our method does not necessarily validate the text of Costas' message, if the hash is not used. Just the links. But, as observed with phishing, it is the links that are the vital element of most phishing, because they can take the user to a fake web site, or to upload to that website personal data that the user might have entered in the message, if it is constructed as an HTML form, for example.

Which brings us to this point. Optionally, the plug-in might have a policy that it will not validate a message with this tag, if it contains a form. The reason is that phishers often have 2 ways to get users to submit their information. The message might look like it is from Bank0, and contains a form for the user to fill in and then press submit, which sends the information to the phisher, and not the bank. The other way is with a hyperlink to the phisher's web site, which looks like Bank0. As a result of the former method, some banks have taken to warning customers not to fill out any forms in messages purporting to be from them. Instead, the customers should only fill these out on the web site of a bank. Our method here is adequate to protect Lucy and Bank0, even if the plug-in lets her fill out a form in Costas' message. But the plug-in may still not validate, to enforce a good practice. Lucy may (should?) be able to change the plug-in's policy. But she may want to keep it at this strict setting just to reinforce good practice by her.

Another reason is that her plug-in is on the browser or viewing program that she regularly uses. If she occasionally uses another browser that does not have the plug-in, then adhering to good practice helps reduce the risk to her.

Plug-in Functionality

We extend the discussion in “2458” about the functionality of a plug-in for the user's browser or message reading program. The user, Sarah, might be able to select the plug-in and indicate that she thinks the current web page is a fraud. This is useful when the plug-in is unable to validate or invalidate the page. Suppose, for example, we have an extreme case of no links in the page. But the author might be trying to persuade Sarah that he is from a bank, and wants her to reply with some of her personal data, and his address is valid. Plus, the page does not have a notphish tag. In this case, the lack of links makes such a message format undesirable to phishers. Our current methods may be unable to algorithmically mark it as invalid. But Sarah might do so. Then, the plug-in could relay this page to Sarah's ISP or to our central aggregation service, or to the authorities. (The plug-in might ask Sarah for permission to send out her message, first, if the page contains a message sent to her.)

Optionally, the plug-in could run an extensive analysis of the page. This can involve the methods of the Antispam Provisionals. Plus, it could use other methods, like Bayesians and artificial intelligence. Typically, such analysis is too computationally intensive to run on every page or message that Sarah looks at. But for a suspected fraud, she might want to see the results of such an analysis. (Some of this analysis may be language specific.)

A very simple initial analysis might be for the plug-in to search for the presence of any of the names of the companies in its list of valid domains (that are implementing the methods of “2245” and “2458”). Plus, it could also look for keywords associated with those companies or the industries that they are in. The presence of these could be used as heuristics leading onto more extensive analysis. Several of the canonical steps in “0046” will be useful here. For example, if the page author tries to obfuscate the word “bank” by writing it as “ba<dummytag>nk” (assuming the page is HTML), because the tag will not display in a browser, then one of the canonical steps removes such tags. Or, if he tries to replace a character by its ASCII code, then another canonical step undoes this.

If the analysis were to indicate that the page or message is a fraud, then the plug-in would change state. Plus, it could upload the page, as before.

Optionally, if the plug-in were to upload a message designated by Sarah as suspect, it could also allow her to add a comment, as to why she thinks it is bad.

Aggregator Hierarchy

In “2458”, we described how the plug-in can interact with an Aggregator. Here, we continue that discussion. To a plug-in, the main utility of an Aggregator is to reply (i.e. validate) that a given notphish tag, with an unfamiliar address, is from a reputable address or not. If so, then in future, the plug-in could perhaps contact that address directly, in order to validate a tag purporting to be from the address.

Provisional “2458” described a single Aggregator. But there could a hierarchy of these. If the methods of our inventions become widely adopted, then there is incentive for many midlevel or small businesses to want to register with an Aggregator, so that their outgoing messages can be validated. But this registration should entail non-trivial checks on the applicant. Because there is a risk that a phisher might form an ostensibly respectable business, and then have it apply at an Aggregator. If the phisher then gets on the Aggregator's list of reputable companies, she can send out tagged messages that will validate at the plug-ins.

Though, of course, these will not validate if she attempts to mimic a bank, and uses links outside the bank's Partner Lists. But she is at least able to send messages, using her company's correct address as the sender, that will validate. This validation might be sufficient to fool a few people to give her their personal data. Still, it should be of much less damage than current phishing which pretends to be from a major bank.

Analogous to the situation when a merchant ostensibly wants to let customers use Visa or Mastercard credit cards. The merchant has to apply to those organizations. Typically, unless the merchant does a very high volume of business, it won't be allowed to process the charges itself. Instead, it has to go through an intermediary, who charges a fee and who takes on some of the risk that the merchant might defraud it.

Likewise, we can have a global Aggregator, who can validate several thousand large companies, say. Then, for smaller companies, it can subcontract this to a second level of subaggregators. This group might be geographically dispersed, so that a company might or should apply to one of those in its region. Another reason for this is that the rules for financial validations might vary with country. So a local subAggregator might have better knowledge of these, and be better placed to validate, especially if this requires physical on-site inspection or audit of the merchant. Of course, there might be several levels of subAggregators.

A subAggregator could charge a merchant for its audit, and pass a portion of this to its parent. A subAggregator may assume some liability for the merchants it approves. Which is part of the justification for the fee it levies.

SubAggregators can also have another role. When a plug-in contacts an Aggregator or subAggregator, then that might redirect it to a subAggregator for its region. This helps make the query methods scalable on a global basis. Then, subsequently, the plug-in can default to that subAggregator. This follows the general idea of the Internet's Domain Name Service, and the global hierarchy of DNS servers.

The global Aggregator may decide to have a validation criterion that companies that are widely known and already validated by some external agency or body, would be validated by it. For example, the top 400 or 500 industrial companies in the U.S., and similar groups in other major countries. But because subAggregators might deal with much smaller companies, the validation process should be rigorous. Specifically, it needs to be far stricter than the process of registering a domain name.

Aside from dealing with plug-ins, a subAggregator might also interact with ISPs in the fashion of the Aggregator.

Another important benefit of the methods of this Invention and the Antiphishing Provisionals is that the plug-in not needing special encryption facilities should facilitate its deployment globally. Some governments might restrict or wish to prevent their citizens from possessing advanced encryption or authentication tools, especially if these tools might be widely distributed to be used with browsers. Or a government might prevent the export of such tools that were developed within its borders. But the most our plug-in might need is to use the https protocol, for channel encryption. Now standard on most or all browsers. As a de facto matter, governments have little means of stopping their citizens from using browsers with this protocol, short of shutting down the Internet within a nation's borders. But they may prohibit any more advanced tools. Our plug-in avoids this issue.

This is in contrast to other methods of antiphishing that involve strong authentication or encryption of individual messages. Phishing is a global problem. But those methods might not be deployable globally, for the reasons outlined above.

Restricted Lists

We now describe a significant expansion of the scope of this Invention. The starting idea is that of a Partner List (PL), which is a list of approved base domains that can exist in a message purporting to be from a company. Provisional “2458” then expanded this to the desktop by having a plug-in, which looks for a certain tag (which we call <notphish>). So that our analysis could be applied to web pages as well as messages. If the tag was present, the analysis would then describe the page as valid or invalid. But if the tag was not present, then no analysis would be done, and the plug-in would then indicate this as a default “tag missing” state.

In what follows, when we refer to an Aggregator, it can also be taken to mean a subAggregator.

Consider our example bank, Bank0, with its base domain of bank0.com. It can construct a “Restricted List”. This is a list of domains, or URLs or URIs, or some other network addresses, where for all of these, it owns those addresses. The intent is at these addresses are web pages or assets (like image files), for sensitive operations, like a user logging into her account. If the address is a domain, it does not have to be a base domain. For example, it might be login.bank0.com.

Bank0 can then send these in any fashion, electronic or otherwise, to an Aggregator or ISP. It can also make this information queryable programmatically from its web site. So an Aggregator or ISP or plug-in might make a query and then obtain the Restricted List.

Now imagine a user at a browser or equivalent program, containing our plug-in, who is looking at a web page. This includes the important special case of where that page is showing a message, in any electronic communications modality (email, SMS, . . . ). Suppose the page lacks the <notphish> tag. The plug-in proceeds to find the links, and derive the base domains from these. These links are not just outgoing hyperlinks, but also incoming links. The latter are typically used in HTML to load images from some network address.

Let L be the set of links, and B be the set of base domains. Let X be the set of base domains of important companies, which presumably includes bank0.com. X is independent of the web page under scrutiny.

Suppose the plug-in has X held locally. Then it sees if any member of B is in X. If none, then it ends the analysis of the page. Else, it asks an Aggregator for the Restricted Lists belonging to (B intersect X). Call this Y. Of course, it might already have some or all of these lists, based on earlier activity. In this case, it might only ask the Aggregator for Restricted Lists that it does not already have.

If the plug-in does not have X, then it might send B to an Aggregator. Who would then reply with the Restricted Lists belonging to (B intersect X).

A minor variation of the above is where the plug-in caches some subset of X. It could then apply the operations of two paragraphs prior to this subset, to get a Y1, say. Then, it could take B, or some appropriate subset, and apply the method of the previous paragraph, to get a Y2, say. After which, it can get a total Y=Y1 OR Y2.

At this point, the plug-in has Y. If all the domains, or possibly entire links, in L are in Y then the plug-in can classify the page as having a warning level MildWarning, which is different from, and less severe than the Invalid classification for a page with a <notphish> tag. We now have generalized the idea of Invalid to a multivalued range.

But suppose some domains, or possibly entire links, in L are not in Y. This is more suspicious. Call this state WorseWarning. For example, Amy might have a web page that loads images from login.bank0.com. But her page also has an outgoing link to some other address unaffiliated with Bank0. If Amy had put a <notphish> tag, then our earlier analysis would suffice to classify the page as invalid. But by omitting the tag, that earlier analysis would just say “default”.

Arbitrarily, a number could be assigned to each state. We give example numbers here to illustrate the concept. We now have these states:

Valid=1. When a page with <notphish> validates.

Default=0.

MildWarning=−1.

WorseWarning=−5.

Invalid=−10. When a page with <notphish> invalidates.

The above takes the convention that the more negative a number, the more suspect a page.

In the above, we have primarily discussed web pages. But if a web page is at an ISP, and showing a message, then we would apply the above only to the message itself, using “2528” to find the message within the page. If messages have a header, then the tag might also appear in the header, as opposed to being in the message body. In this case, while the format of the notphish header tag is arbitrary, it probably would not be of the form <nophish>. In email, it might be “X-Notphish”, following the convention that extended headers start with a capital X.

For brevity, we will continue to discuss web pages, with the understanding that we can also apply these ideas to rating messages.

So if a web page has a negative state, then the plug-in can change its visual representation. For example, if Invalid is shown as red, then MildWarning might be some lighter shade of red, and WorseWarning be some shade intermediate between the two.

Or we might choose a traffic light metaphor. The use of (red, yellow, green) in traffic lights is a global standard. So we might take green to be valid, yellow to be MildWarning or WorseWarning, and red to be invalid, and all lights off to be the default. In this case, if the user were to press the plug-in button when it is yellow, it might show a pop up window with information as to whether the page has a MildWarning or WorseWarning. An advantage of using traffic light colors relates to the observation that phishing tends to target the inexperienced or less educated users. More easily fooled. The choice of the traffic lights can be so intuitive that such users could especially benefit from it.

Likewise, if a plug-in has some aural representation, then it might choose different sounds, but related in some way that users might find intuitive.

If a web page has a WorseWarning, then the plug-in might highlight or turn off the links that are not in the Restricted Lists. This follows the approach for an Invalid page.

So far, we have discussed operations at the plug-in. Most, if not all of these steps, can also be done at the ISP, with possible modifications or extensions described here. If the ISP finds that a message has a MildWarning or WorseWarning, it can do special steps. For example, it might write a header line giving the warning level. Of course, if it finds the message to be Invalid, then it can also do this. Then, any client message viewing program that downloads messages from the ISP can use this header line to apply special treatment to the message. For example, the viewer might have an Inbox and a Bulk folder, where the latter is meant for spam. Our header now lets the viewer have more folders, for example. Perhaps one for each negative state.

If the ISP and viewer program cooperate in this fashion, it can be seen as offering more protection to the user. Notice too that the viewer need not be running our plug-in.

For messages that generate these warnings, the ISP might also apply further analysis. Possibly as a result, it might forward some such messages to the authorities or banks in question.

The use of the Restricted Lists gives more protection to banks and other companies. A bank can segregate the sensitive places in its website into specific addresses, that few outsiders should be linking to, in messages or web pages. This is distinct from its home page, or pages with purely informational content. News articles or indeed anyone commenting on the bank might well link to these pages. Nor does our method prevent anyone from linking to the the Restricted List. But it provides a classification that can help reduce the chances of a casual user been defrauded.

It also lets us address the problem of a fake website with pages purporting to be from a bank, say. The website might have a name similar to the bank. While a phisher might have a web page for this, directed to by messages she sends, it is also possible for a fake website not to use phishing to attract users. It might try manipulating search engines to direct traffic to it, for example.

Directionality

We now have Partner Lists and Restricted Lists. For each item in either list, there could be an optional extra parameter, which can take three values—for incoming links only, outgoing links only or both. This lets the owner of a list fine tune the usage of the links in web pages or messages. By default, if the parameter allows both, then it might be omitted. This corresponds to our earlier usages.

Increased Addressing Options

In the Partner Lists and Restricted Lists, it is also possible to expand the syntax to include a range of allowed addresses. Suppose an item is described using IPv4 notation, as 2.3.4.5, for example. The lists might also allow a notation like 2.3.4.*, which means that a link in that range of addresses would be considered valid. Analogous statements could be made using IPv6 notation.

Large Company Constraint

Consider again the phisher Amy. She wants to attack Bank0, which has its Partner List propagated to the Aggregator. If she writes a <notphish> tag with an address of bank0.com, and puts this in a message, with links to bank0.com and to her domain, then an ISP or plug-in will invalidate it, because her domain is not in Bank0's list. But suppose she manages to convince an Aggregator that her domain, fakeAmy.com, is a reputable business. So she can now issue her own tags, with an address pointing back to fakeAmy.com, and she can register her Partner List with the Aggregator. This list can say (fakeAmy.com, bank0.com). She then sends out messages, or write web pages, with the tag, and with links to both domains. In this way, she hopes to mislead readers.

It should be noted that she still has to do more work than previously. The registration process should be deliberately rigorous, with manual, real life identification of the person applying. So our methods as currently described, form a significant hurdle. But suppose she overcomes this. In part, perhaps by having someone else be a dummy owner of her business.

To respond, the Aggregator can search any Partner Lists submitted to it by companies that are already registered. It has a core list of major financial institutions and other large companies. Call this list T. If a list submitted by a company not in T includes any companies in T, then the Aggregator can submit the list to those companies for approval. This can be done in a programmatic fashion.

Alternatively, T might be the entire set of companies registered with the Aggregator.

Lists and Tags in Web Services

All our earlier discussions concerned messages or web pages that would be manually viewed or heard by a human user. Our methods can be generalized to the nascent field of Web Services [WS]. The active entities in WS are computer programs, typically running on different nodes of a network, which is usually the Internet. The programs interact with each other, by exchanging documents. By convention these are often in XML format, and specifically might conform to the Web Services Description Language [WSDL]. A document might be some combination of data and instructions. Under WSDL there is provision for a document to be authenticated by various methods. Typically, the authentication might be of the entire document, or precisely defined subsets. In any event, the methods are invariably computationally intensive because of the complexities of the authentication methods.

We offer a lightweight alternative in the spirit of our previous methods. In some instances of a WS document, the crucial elements might be links, incoming or outgoing. Where an incoming link might mean get some data from that address. While an outgoing link might mean send some data to that address.

We suggest that a WS document might include a <notphish> tag. The precise syntax of which need not be the same as in our earlier usages. But for simplicity we suggest its syntax be as similar as possible. The crucial idea is that there is an address variable, giving us an example like this:
<notphish a=“bank0.com”/>

It tells the program to go to an Aggregator and find the WS Partner List for bank0.com. In general, this might be different from the Partner List for messages or web pages. For the Aggregator to know that it should return the WS Partner List, instead of the other Partner List for bank0, the query from the program to the Aggregator might include a flag that indicates a WS context.

Of course, if the program gets a WS Partner List from an Aggregator, it may cache this, to speed up processing the next time it gets a document purporting to be from Bank0. It might also register itself with the Aggregator, so that the latter can send any changes to this list. Or it could periodically poll the Aggregator for any changes.

Thus, a WS program might require that its input documents contain a <notphish> tag. It will not process documents lacking the tag. Otherwise, with such a tag, if any links in the document are not in the WS Partner List, the document is considered invalid, and will not be processed.

An important difference between the WS case and our earlier cases is that when a WS program gets a document from another program, it may have to reply with some data. Thus the Partner List may contain a specific set of allowed addresses, from which queries can come from.

It is also possible for the program to directly query bank0.com, instead of going to an Aggregator, if the program has a list of such domains and bank0.com is on that list.

A Restricted List can be used in WS along similar lines.

It can be seen that our method is very lightweight compared to current WS authentication methods. It does not invalidate the usage of those methods. It offers a middle ground between no authentication in any sense, and full authentication.

Currently, there is no indication of an abuse of WS that would suggest needing our method as a countermeasure. But WS are still incipient. Such as do exist are often experimental efforts. There is relatively little money in WS electronic commerce. If this were to change, there might be need for our method.

It should be understood that in the above, where we refer to Web Services, we use this term to conform to existing usage. But the gist of our ideas also applies to any distributed arrangement of computers interacting in a similar fashion, even if the terms WS and WSDL are not used to describe this interaction.

Reduced Liability

Our methods also have an advantage over methods that may lead to banks (and other companies) using them running a risk of liability. For example, a bank may use a method that forces the customer to perform extra validation steps, when the customer contacts the bank via the Internet and wants to transfer money to a merchant. But in some jurisdictions, this may expose the bank to some liability for losses. In contrast, our methods do not intervene during any actual financial transaction steps. At the plug-in, our methods are strictly advisory. Even if the plug-in were to turn off suspect links in a suspect web page or message, say, this is a policy setting of the plug-in that the user can change.

At the ISP level, suppose it were to block (i.e. not deliver) a message to a user, if it found via our methods that the message was phishing. Most ISPs have broad leeway to make such determinations about suspected phishing and spam messages. And it is an ISP that would make such a decision, not a bank, though it may use input from the bank, in the form of the Partner or Restricted Lists.

Image Messages

We now treat a special case of phishing messages, composed solely or mostly of one or more images, where these are selectable links. The images might be present in the message, as attachments. Or they might be loaded from some network location, when the message is viewed by the recipient. The outgoing link in an image goes to the phisher's website. Here, none of the outgoing links go to a bank or other large company. And the purported sender base domain is not that of such companies. Also, if the images are loaded from the network, none of these locations are at those companies. This differs from the messages we previously considered. Those had at least one link to a bank. Hence, we were able to use the bank's Partner Lists to verify the other links in the message.

This is a limited case, because the phisher cannot link to a bank, or have a sender address at a bank. Hence, in and of itself, this case should be less likely to fool users. So even if the methods we describe below are not applied, forcing phishers to congregate here should significantly reduce losses by banks.

Also, we include the case here where the message has text and just a textual link (as opposed to an image link) to the phisher's website, without any links to a bank. For brevity, where below we refer to a message having an image, it could also refer to this case.

Plus, another case considered is where the message has a form for the user to input personal data, and the submit button of the form sends it to the phisher's website. The analysis below of the phisher's website can also be applied to this message.

So how can we detect a phishing message that directs the reader only to the phisher's website?

First, some preliminaries. Let Amy be the phisher. Let us assume that the message only has one image. Though in general it could have several. The targeted company is taken to be a bank, though it could be other types of companies. Let Bank0 be one of these banks, with a domain or bank0.com. We take the recipient's viewing program to be a browser, though it could be any other program capable of showing a hypertext message, and following links in it.

It can be expected that the image contains some text, purporting to be from a bank, and urging the recipient to click on the link in order to enter some of her information.

We can apply the methods of the Antispam Provisionals with some modifications. These are applied at an ISP to its incoming messages. For each message, we can find its links, both incoming (for loading images) and outgoing. If none of these links are to a bank, then we might have a phishing message of the type considered here. As above, we now assume there is only one such outgoing link in the message. From it, find the base domain. Across all the incoming messages received in some time interval, we find the frequencies of such messages.

Note that we are not making a Bulk Message Envelope, as described in “1745”. This could be done. But our methods of this Invention can be faster, which is important given the need to quickly determine phishing messages, and so reduce losses due to those.

Having tallied the base domains by their frequencies, we can then use this as input into some logic that decides which of these to investigate further. For example, we might omit messages pointing to *.edu or *.gov domains. Plus, we might have a white list of large organizations that we deem very unlikely to host a phisher. Like redcross.org or nature.org. This list can be large, because it would be used as a hash table, when searching for whether a domain is in it or not, and the lookup time goes as log(n), where n is the number of entries.

The logic might include scrutiny of any text in the message, that is not in the images. This could involve language-specific methods. At the simplest level, we might search for the names of banks. So that if “Bank0” were to be found, for example, then this might suggest following the link. The text search might use the anti-obfuscation techniques of “1745” and “1622”. For example, if the phisher were to put random tags, in order to break up a word, we would remove these. So “B<other>an<random>k0” would become “Bank0”. Or if some characters were written as hexadecimal, we would undo these, before searching for any bank names. Or if Amy were to write invisible text, then we would remove it.

Of course, the message might be purely an image, with no other text.

Obviously, if a message's base domain is a known phisher, then we can immediately reject that message. Otherwise, if the previous logic has not suggested that a base domain be investigated, then we might decide to do so for the top 10% most frequent base domains, say. Or some other percentage of occurrence.

Suppose we have now made a decision to investigate a given base domain, amydomain.com, say. We send a web spider to start crawling at this base domain. Or we can go back to the messages with this domain, and start crawling via the full addresses in those links. The spider can search for various heuristics. As discussed above, it can look for the names of banks. We assume that Amy is impersonating Bank0 at her web site. So her web pages should contain several references to Bank0. Plus, the pages might mimic the visual appearance of Bank0's actual website.

Therefore, before all this analysis, we can cache the websites of the banks who are using our methods. Then, when we detect “Bank0” in Amy's web page, we can compare that page with Bank0's actual pages. And likewise for any other pages on her website. Because unlike a general purpose non-phishing spammer, who can write arbitrary content at her website, Amy is constrained by the look-and-feel of Bank0's website. In other words, we can use Bank0's pages as a “positive template”, and check for possible overlap in content and presentation of that content with Amy's pages. The overlap in content might be due to Amy copying several phrases or entire sentences from Bank0. While she could in principle avoid this entirely, doing so would reduce the chances of fooling a visitor. It would also entail more work for her; driving up her costs. Of course, prior to comparing for overlap, we would use our anti-obfuscation methods.

Comparing presentations can be equally useful. Bank0 might have static images on its website, that appear in its pages. Amy could copy these to her website. So, if we see an image on her website, we could compare it to any of Bank0's images. To combat this, Amy might put random changes into the low order bits of the image, to throw off an exact match by computer, while still presenting the same overall image to a human reader. In return, our comparison of images might be based on the higher order bits of an image.

Another technique that Amy might employ is changing the format of a copied image. Suppose she takes a Bank0 image that is in the GIF format. She transforms it to JPEG format, say, using commonly available tools like ImageMagick.™M, xv or Photoshop.™. One countermeasure we could adopt is that we might store copies of banks'images, but converted to some common format, like GIF. Then, from Amy's website, we convert images to GIF if they are not already in this format, before making a comparison with our stored images.

Comparing the presentations between Amy and Bank0 can also involve more than images. We could compare the choices of font families, sizes and colors. Since Amy may try to mimic Bank0 in this regard. Note that when comparing colors, we should not just compare for exact matches of colors. Suppose a bank has a title in pure blue, perhaps represented in RGB notation as (0,0,255), where we assume that the colors are stored as 8 bit values. Amy might copy the title, but present it as (2,2,252). Which is close enough to pure blue that most readers will not notice any difference. So color comparisons need some empirical metric of closeness, as perceived visually. In “1745” and “1622”, this was discussed as one of our canonical steps when finding Bulk Message Envelopes.

We could also look for any structural similarities. Does Amy's page use frames, and dimension those similarly to one of Bank0's pages? Does Amy's page have a line of links at the bottom, similarly to one of Bank0's pages? These structural features of a page are very difficult to conceal.

Also, the interconnection topology of Amy's website can be compared with Bank0's website. Plus, the topology of Amy's website and any outside websites that it links to, can also be compared to Bank0's website. This can account for the possibility that Amy may be controlling several websites.

Now suppose Bank0 has a Restricted List. Which is a list of its URLs or domains that no one else should be linking to, though it cannot prevent this. Typically, an entry might be a login page for its customers. We can use the Restricted List as a“negative template”. We compare the Restricted List web pages for Bank0 with Amy's website. As earlier, we compare both the content and the presentation. Any detected similarities can be considered highly suspicious. More so than for any others of Amy's pages that might be similar to non-restricted pages on Bank0's website. If we consider the crucial example of a restricted page being a login page, then this is something that Amy would very much attempt to imitate.

So we can imagine two sets of styles (heuristics). One set measures any similarities to Bank0's non-restricted pages. The other measures any similarities to the restricted pages. Empirically, or by using external logic, we can then decide if the presence of enough styles indicates a phishing website. If such a decision is reached, then we can immediately block all messages pointing to that website. Plus possibly inform Bank0 and various authorities.

Whether or not Bank0 uses a Restricted List, we can also search Amy's website for the presence of pages with forms, where the reader might be asked to submit personal data. The forms are crucial, because without them, Amy cannot get any personal data. In a form, the user input would consist of boxes in which the user would type data, plus also possibly buttons which the user might pick, or menus from which the user could pick items. For these, imagine the user being asked for her date of birth, where the days, months and years are given from menus, to make it easier and less error prone for input.

Next to such input widgets would often be text labels. These labels are often single words or short phrases, that tell the user what type of data is requested. These key words would mimic what Bank0 would use on its forms. But also, across all banks or other companies, there would often be a set of often occurring key words, for a given a language and country. For example, consider the English language and the United States. Examples of such words or phrases might be (“username”, “surname”, “password”, “date of birth”, “birthday”, “account number”, “social security number”). In other English speaking countries, slightly different lists might be devised. For example, “social security number” would be replaced by “tax file number” in Australia. For other countries and languages, it would also be straightforward to amass similar lists. In any language, there exists only a few common words for the main types of personal data.

We can treat such words or phrases as tokens, and search for their presence in labels near or next to input widgets. For each page, we might associate an integer style, NumKeyWords, which counts up the number of such tokens found in labels near input widgets in the page. The greater this number, the more personal information the user is being asked for, and the higher the possibly significance of the page. An elaboration on this is to have a positive weighting associated with each token, where the greater the weighting, the more sensitive the number. Then, NumKeyWords would have the weights added to it, for any detected tokens.

Alternatively, this style might be held as a boolean, and set true if at least one such token is found near an input widget. Quicker to compute, but lacks a potentially useful measure of how many such items there are in a page.

Note that we do not need to do semantic analysis for the label contents, given that the labels are effectively restricted to words or short phrases. An important simplification.

To avoid our searching of the form's labels, Amy might replace the labels with images of text. If we see any such images, near or next to input widgets, then we might increment an integer style, NumImageLabels, for that page. We might treat this as very suspicious, given that it is far simpler to write text into a label than to make an image of text and then use it in the label. If desired, we might also apply the methods of Optical Character Recognition to the images, to try to find the text presented by them, and with any such found text, to check these against a list of key words. In such a case, we might apply any weightings for those tokens, as was suggested for NumKeyWords.

In the above, the phrase “near or next to” is deliberate. To throw off a simple use of our methods, which just looks for a label next to an input widget, Amy might write one or more such adjacent labels containing empty text or one space or a few spaces. Such labels are effectively invisible to casual inspection. Then, in a label next to one of these, but now slightly further away from the input widget, Amy writes the actual text or an image.

We also elaborate on what “next to” means. European languages are read from left to right. So forms in these languages often have the label to the left of the input widget. But in some other languages, like Arabic, which reads from right to left, the label might be to the right of the input widget. And in a language like traditional Chinese, which reads from top to bottom, the label might be above the input widget.

The use of our method means that Amy will find it very difficult to mimic Bank0. It forces her to expend more effort into crafting her pages. She cannot just copy Bank0's pages and make small changes to them. But the more changes she makes, the less the visual similarity to Bank0, and hence the less the chance that a visitor will be fooled.

Our methods above can be applied to any markup language that also implements hyperlinks. This includes, but is not limited to, HTML, and various proprietary formatting languages like Microsoft Corp.'s DOC and Adobe Corp.'s PDF.

Now suppose that by the above methods, we have determined that a given message is from a phisher. We can then use this knowledge in various ways to aid the detection of more such messages in the incoming data stream. For example, from the message's header, we can look at the relays. Some of these may be forged. But if we have several messages found to be phishing, and with common relay paths, then this might be used to scrutinize other messages with those paths.

Or we could use the subject line of a phishing message, and search for other messages with that subject, or similar, and apply the above tests to those. For the general case of spam, this does not work very well. Because spammers found countermeasures. Like putting random text in the end of the subject. Or having a subject unrelated to the body of the message. Or mis-spelling words in the subject. But for phishing, these would all act to degrade the effectiveness in fooling the recipient.

Or suppose the phishing message has some text, and the link to Amy's website. It is assumed that such text is what is left after we've applied canonical steps to remove any invisible material, and put the remaining text in a standard form. Having detected a phishing message, we can leverage this by searching for this text in other messages (after applying those canonical steps to the messages). It is hard for Amy to put in randomness into this visible text, as per the subject line, without arousing suspicions in the reader.

Our method of this Invention can also be used without necessarily starting from a set of messages. In general, the input might be a set of addresses (base domains, URLs, URIs . . . ) to which we apply our method. So if we imagine an implementation of our method as an appliance (hardware or software), then as such, it can have use by other applications which need some addresses to be investigated for phishing.

Another application might be a general purpose search engine. It could be programmed to periodically search for Bank0. (That is, it has a list of large banks, and it does this for all entries in that list.) In the search results for Bank0, it might take the top 50, say. From these, it removes any that point directly to Bank0's base domain, or other base domains that Bank0 might own. (The search engine can have already obtained this information from Bank0.) But for any remaining results, it might then send these addresses or base domains to our method. The search engine is looking for any websites that might be manipulating its ranking algorithms to present themselves as Bank0. When the search engine is Google Corp., this is sometimes known as “Google bombing”.

Possibly, various banks might contract with the search engine, to perform this analysis. The advantage here is that the search engine may have extensive coverage of the web, and enough technical expertise, so that it is more economical for a bank to outsource this task.

Instead of a search engine doing the above, an Aggregator, as we have described in the Antiphishing Provisionals, might perform this as a regular service for the banks.

Another application might be a website specializing in financial matters that lets its readers write comments, perhaps in the style of a blog. If the website shows these comments, in such a way that any links in a comment can be selected, then it may want to guard against Amy directing readers to her website, while posing as Bank0. So the financial website might run our application automatically as a filter on user submissions, and reject any that fail our method.

Another application might be an ISP or any other organization using our Antispam Provisionals, and finds groups (possibly clusters) of spammer domains. These domains might be input into our method to find any phishing websites.

Another application might be an antivirus company that finds network addresses in viruses. If the virus appears to be capable of sending information to an address encoded in it, then this address might be searched with our method. This is especially useful because of the discovery that many phishers send out viruses to take over computers, and use those in phishing, in part as destinations referred to in messages.

Thus far, these applications involve the active use of our method. But suppose an organization, like an Aggregator or ISP, were to use our method on a regular basis, to find a current list of phishing websites. This could be used by an Instant Messaging service, or IRC operator, to possibly block real time messages that might point to those websites. Here, the real time nature may preclude the direct use of our method. Alternatively, the IM or IRC service might record its users' messages over some time period like a day, and then apply our method. Any phishing websites can then be blocked for some future period of time.

What is claimed is:

1. A method of adding a field to the Notphish tag, which lets the company authoring the tag and the message containing the tag, to send the message to a few recipients, who can then use their browsers and plug-ins to verify the links or the text, where the latter verification is done by hashing the text; and where the plug-ins communicate with another company (“Aggregator”) which has received the correct links and/or hash of the text from the first company.

2. A method of a company publishing a Restricted List (“RL”) of its web pages, that external web pages, or electronic messages not from the company, should not link to or copy.

3. A method of using claim 2, where the Restricted List is held by an Aggregator, which disseminates it and the name of the company which authored it, to a browser (or plug-in) running on a user's computer. Where that program checks the current viewed page for similarities to any on the RL, and if so, and if the page is not at the RL's author's website, then this is used to suggest possible phishing.

4. A method of using claim 3, where instead of a browser doing the checks, these are done by a message provider on incoming or outgoing messages.

5. A method for an already detected phishing website of using a set of electronic messages, and searching for domain clusters containing that website; if so, then the other domains in the cluster are analyzed as possible phishing sites, with appropriate action taken against those found to be phishing.

6. A method of using claim 5, where the electronic messages are email.

7. A method of using claim 5, where the electronic messages are Instant Messages.

8. A method of using claim 5, where the electronic messages are Short Message Service messages.

9. A method of using claim 5, where the search is made for domain clusters with domains that map to network addresses close to the address of the phishing website.

10. A method of using claim 5, where instead of searching in the domain metadata space, other metadata spaces are searched.
